(19) United States
(12) Patent Application Publication
(10) Pub. No.: US 2025/0327420 A1
(43) Pub. Date: Oct. 23, 2025

(54) VAPOR-PHASE LUBRICATION FUEL ADDITIVE FOR HIGH SPEED LIMITED-LIFE BEARINGS

(71) Applicant: BlueHalo, LLC, Northwest, AL (US)

(72) Inventors: Hitesh K. Trivedi, Northwest Huntsville, AL (US); David T. Gerardi, Northwest Huntsville, AL (US)

(21) Appl. No.: 19/186,297

(22) Filed: Apr. 22, 2025

Related U.S. Application Data
(60) Provisional application No. 63/637,439, filed on Apr. 23, 2024.

(51) Int. Cl. F02C 7/06; F02C 7/22

(52) U.S. Cl. CPC F02C 7/06; F02C 7/22

(57) ABSTRACT

Systems and methods for providing lubrication to a gas turbine engine are described. An example gas turbine engine includes a plurality of bearings disposed along an axial length of a rotatable shaft to provide rotational support between a static structure and at least one of a compressor and a turbine of the gas turbine engine. The gas turbine engine further includes a fuel system operable to deliver a mixture of fuel and lubricant sequentially to at least one of the plurality of bearings and the combustor so that during operation of the gas turbine engine, at least the lubricant within the mixture is in a liquid phase prior to being received by the at least one of the plurality of bearings, and in a vapor phase once the lubricant is delivered to the at least one of the plurality of bearings.

### CROSS-REFERENCE TO RELATED APPLICATIONS

This application claims priority to and benefit of U.S. Provisional Patent Application 63/637,439, filed on Apr. 23, 2024, the entire disclosure of which is hereby incorporated by reference.

### FIELD OF TECHNOLOGY

The present disclosure relates generally to providing lubrication for turbomachines that use high-speed bearings, and more particularly to providing a lubricant as a fuel additive that forms a fuel-lubricant mixture which can be introduced through a fuel delivery system to the high-speed bearings during the operation of a limited-life turbomachine to provide vapor phase lubrication thereto prior to having the mixture combusted.

### BACKGROUND

Bearings are used to provide, among other things, rotational support between adjacently spaced moving and stationary objects, such as between a rotating shaft and a stationary journal or housing. One common use includes their placement along the axial dimension of the shaft of a gas turbine engine.

A common metric used to identify the correct lubricant for a particular bearing environment is known as the DN number, which is the product of the bearing bore diameter D (in millimeters) and the shaft's rotational speed N (in revolutions per minute or rpm), which translates to the rotational speed of the bearing. The shaft's rotational speed in an aircraft gas turbine engine can produce bearing speeds anywhere between 2 and 3 million DN. The amount of heat generated by these speeds can raise the bearing temperature anywhere between 220° C. and 430° C., or more. These high temperatures are well beyond the thermal limit of conventional oil or grease-based lubricants. Despite the advancements in synthetic lubricants designed to improve stability in high-temperature environments, they still have thermal limits that high-speed gas turbine engines can surpass.

Within the realm of aircraft gas turbine engines, the larger gas turbine engines are those that are sized to power larger piloted aircrafts, such as those for commercial purposes where people or cargo are being transported, as well as those for military tactical and strategic military operations that involve heavy payloads. To keep the bearings of such larger engine systems within their designed temperature limits, lubrication systems and related thermal management tools are employed. These systems use a complex arrangement of pumps, piping, sumps, oil coolers, parasitic compressors or fans, and associated controllers to ensure that the lubricant used is performing as intended—i.e., keeping the lubricant within its thermal limits. In addition to their high operational and maintenance costs, these complex systems significantly increase weight. Nevertheless, the substantial size and thrust of these larger engines allow them to accommodate these drawbacks and still function as expected.

In contrast, space and weight limitations on smaller gas turbine engines, such as those used in limited-life (i.e., expendable) systems like in a missile system, cannot afford to be outfitted with heavy and complex lubrication systems. Moreover, smaller gas turbine engines designed for missile use tend to operate at higher DN values, which exacerbates an already thermally-challenging bearing environment, even for high-temperature lubricants.

The foregoing examples of the related art and limitations therewith are intended to be illustrative and not exclusive, and are not admitted to be “prior art.” Other limitations of the related art will become apparent to those of skill in the art upon a reading of the specification and a study of the drawings.

### BRIEF SUMMARY

In the present disclosure, vaporizable organophosphorous materials may be mixed with the engine's fuel as part of the fuel delivery system's normal fuel delivery operations, according to some embodiments. It is further contemplated that the use of alkylated triphenyl phosphate esters, as a lubricant in a bearing assembly, can be particularly beneficial because the tribologicial properties of these esters can be maintained in high-speed, high-temperature environments to which the bearing assembly is typically subjected. Advantageously, using the lubricant as a fuel additive allows the lubricant to be routed to the bearing assembly prior to being subjected to a combustion process in the gas turbine engine's combustor. As a result, the engine does not require a separate lubrication system.

In some implementations, the fuel-lubricant mixture is supplied to the bearing assembly at a temperature low enough to keep the lubricant in a liquid state. Once the fuel-lubricant mixture enters the bearing assembly, which operates at elevated temperatures (i.e., higher than the supplied temperature of the fuel-lubricant mixture), the lubricant in the fuel-lubricant mixture vaporizes and attaches to various components of the bearing assembly. More specifically, the liquid lubricant, which has been pre-mixed with the fuel, vaporizes when it comes in contact with the hot surfaces of the components of the bearing assembly. Once vaporized, the lubricant is adsorbed on the exposed surfaces, reacts, and forms a thin lubrication layer (e.g., a lubrication film or coating).

According to an aspect of the present disclosure, a gas turbine engine is disclosed. The gas turbine engine includes a static structure, an inlet, a compressor fluidly downstream of the inlet and secured to a rotatable shaft. The gas turbine engine further includes a combustor fluidly downstream of the compressor, a turbine fluidly downstream of the combustor and secured to the rotatable shaft, an exhaust fluidly downstream of the turbine, and a plurality of bearings disposed along an axial length of the rotatable shaft to provide rotational support between the static structure and at least one of the compressors and the turbine. Additionally, the gas turbine engine includes a fuel system operable to deliver a mixture of fuel and lubricant sequentially to at least one of the plurality of bearings and the combustor so that during operation of the gas turbine engine, at least the lubricant within the mixture is in a liquid phase prior to being received by the at least one of the plurality of bearings, and in a vapor phase once the lubricant is delivered to the at least one of the plurality of bearings.

According to another aspect of the present disclosure, a method for providing lubrication to bearings of gas turbine engines is provided. The method includes providing fuel tank filled with a mixture of fuel and lubricant, delivering at least a portion of the mixture to a bearing disposed along an axial dimension of a rotatable shaft of a gas turbine engine, where at least the lubricant within the mixture is a liquid form prior to being received by the bearing and in a vapor form once the mixture is introduced to at least one heated contact surface of the bearing. The method further includes reacting the at least one heated contact surface with at least a portion of the lubricant introduced thereto to form a lubricating layer on at the least one heated contact surface of the bearing, delivering at least a remaining portion of the mixture from the bearing to a combustor of the gas turbine engine, and igniting, within the combustor, at least the fuel that is contained within the remaining portion of the mixture.

The above and other preferred features, including various novel details of implementation and combination of events, will now be more particularly described with reference to the accompanying figures and pointed out in the claims. It will be understood that the particular systems and methods described herein are shown by way of illustration only and not as limitations. As will be understood by those skilled in the art, the principles and features described herein may be employed in various and numerous embodiments without departing from the scope of any of the present inventions. As can be appreciated from the foregoing and the following description, each and every feature described herein, and each and every combination of two or more such features, is included within the scope of the present disclosure provided that the features included in such a combination are not mutually inconsistent. In addition, any feature or combination of features may be specifically excluded from any embodiment of any of the present inventions.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

The accompanying figures, which are included as part of the present specification, illustrate the presently preferred embodiments and together with the general description given above and the detailed description of the preferred embodiments given below serve to explain and teach the principles described herein.

FIG. 1 is a cutaway view of an exemplary limited-life gas turbine engine that can be adapted to use the vapor-phased lubrication fuel additive disclosed herein, in accordance with some embodiments.

FIG. 2 is a cutaway view of a fuel delivery system that can be used in the gas turbine engine of FIG. 1, in accordance with some embodiments.

FIG. 3A is a plan-view of a rolling element bearing, in accordance with some embodiments.

FIG. 3B is a cross-sectional view of a top portion of the rolling element bearing shown in FIG. 3A over a portion of a rotatable shaft, in accordance with some embodiments.

FIG. 4 shows an exemplary airborne vehicle in the form of a missile that may be powered with the exemplary gas turbine engine of FIG. 1, in accordance with some embodiments.

While the present disclosure is subject to various modifications and alternative forms, specific embodiments thereof have been shown by way of example in the drawings and will herein be described in detail. The present disclosure should not be understood to be limited to the particular forms disclosed, but on the contrary, the intention is to cover all modifications, equivalents, and alternatives falling within the spirit and scope of the present disclosure.

### DETAILED DESCRIPTION

A technical challenge with gas turbine engines, including those used in missiles and other airborne limited-life vehicles, is how to effectively lubricate the bearings without introducing additional weight, complexity, and parasitic losses associated with a separate lubrication system. This technical challenge further extends to maintaining the lubricating properties of a lubricant when the bearings are designed to operate in and/or around hot components of a limited-life gas turbine engine, such as the turbine, the combustor, and the like. In this regard, aspects of the present disclosure provide a technical solution to this challenge by providing a lubricant delivery method that combines a lubricant with fuel to effectively lubricate the engine's bearings while providing fuel to the gas turbine engine. The method and systems disclosed herein eliminate the need for a separate lubrication system, which reduces the weight and complexity of the system while allowing the bearings of limited-life gas turbine engine systems to operate at higher speeds and temperatures.

In some embodiments, the lubricant is designed to offer liquid-vapor phase lubrication when it is pre-mixed with the engine's fuel in liquid form. The mixture is first directed into the bearing assembly before being supplied to the engine's combustor. In some examples, portions of the fuel and the lubricant are pre-mixed together at a fuel tank or other fluidly upstream portion of the fuel delivery system so that the mixture can be first routed to the bearing assembly and then to the combustor to perform its respective lubrication and combustion functions. In some implementations, a small portion of the mixture is diverted to the region containing the bearing or bearings, while a majority of the mixture is routed directly to the combustor. In other embodiments, the entirety of the mixture is first routed to the region containing the bearing or bearings where a portion of the lubricant vaporizes from the mixture and reacts within the bearing while any remaining portion of the mixture is directed to the combustor.

Once the lubricant in the fuel-lubricant mixture has been sufficiently heated by the elevated temperatures of the bearing assembly, the lubricant vaporizes. The vaporized lubricant then bathes or otherwise permeates and reacts with the exposed surfaces of the bearing. In addition to having significant boundary film lubrication characteristics, thermal and oxidative stability, the lubricant must also possess suitable temperature-viscosity index properties for lower temperature operating conditions, such as those during start up. Additionally, the lubricant must have low toxicity.

As previously mentioned, by providing the fuel in the fuel system with the ability to convey a lubricant (such as the alkylated triphenyl phosphate ester (ATPE) discussed herein), a separate or dedicated lubrication system is not required. This approach simplifies the engine design, and in particular the limited-life engine design. Within the present disclosure, a separate or dedicated lubrication system is understood to include various components-such as the aforementioned pumps, piping, sumps, oil coolers or the like that are arranged in a dedicated way for the primary or exclusive purpose of delivering lubricant to bearings or other friction-limited components.

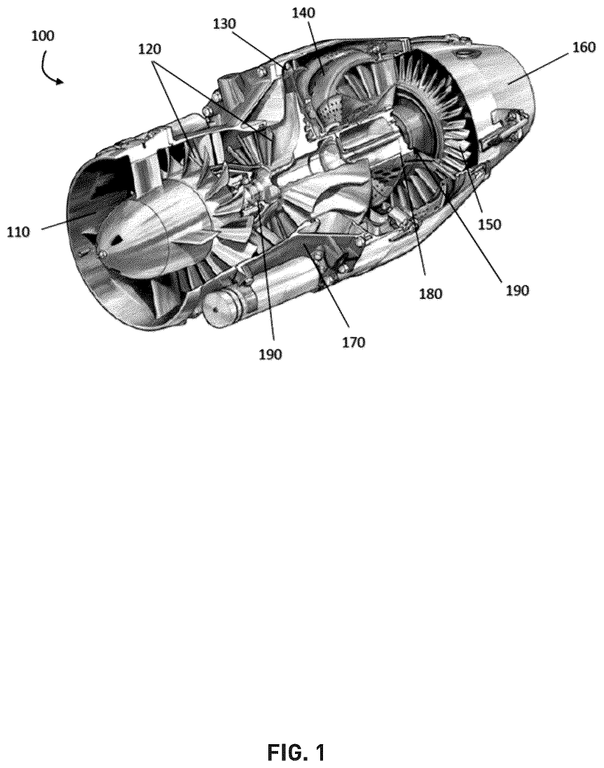

FIG. 1 is a cutaway view of an exemplary gas turbine engine 100, according to some embodiments. In the depiction of FIG. 1, and during normal operation, air enters the gas turbine engine 100 via inlet 110 and exits via exhaust 160. Beside inlet 110 and exhaust 160, there are several flowpath-related components that are used to generate a forward-propelling exhaust gas, such as a compressor 120, a diffuser 130, a combustor 140, and a turbine 150. In addition to the flowpath components, the gas turbine engine 100 includes non-flowpath structures, including a static structure 170 (which may include one or more frames, cowlings, structs, a nacelle or the like), a rotatable shaft 180, and a plurality of bearings 190 (only one of which, in the cold section of the gas turbine engine 100, is shown in FIG. 1). Although not shown in FIG. 1, gas turbine engine 100 may include additional components necessary for its operation. These additional components may include, but are not limited to, mechanical mounting points, power and control electronics, a fuel system, an auxiliary power system (A PU), one or more seals, one or more fans and an afterburner. Notably, the presence of one or more fans would necessitate a multistage turbine and a concentrically-mounted second shaft substantially decoupled from the first shaft under normal operation. In well-understood parlance, when the gas turbine engine 100 does not include a fan and multiple shafts, it is referred to as a turbojet, whereas if a fan and concentric set of shafts are present, it is referred to as a turbofan. Nevertheless, either variant is deemed to be within the spirit and the scope of the present disclosure.

According to some embodiments, lubrication of the one or more bearings 190 within the “cold” sections of the gas turbine engine 100 (i.e., sections related to inlet 110, fan (not shown), compressor 120 or other components of the gas turbine engine 100 that have little or no thermal exposure to the hot gases or other byproducts of the combustion process) may be adequately achieved by routing a portion of either the fuel separately or a mixture M of the fuel and lubricant. However, there is another plurality of bearings 190 that provides support to “hot” sections of the gas turbine engine 100. That is, sections of the gas turbine engine 100 which are subjected to significant thermal exposure from the combustion process and its byproducts. These sections include the combustor 140, turbine 150, exhaust 160 and other components that have been exposed and/or are in frequent or prolonged thermal communication with the high-temperature, high-energy combustion byproducts or related hot product gases. It is the bearings 190 in the hot sections of the gas turbine engine 100 that can benefit most from the methods and systems described herein.

Although much of the discussion pertains to a plurality of bearings 190, it is to be understood that a single bearing 190 may be referred to without departing from the spirit and the scope the disclosure. Similarly, the use of the term “bearing” will be understood to refer to an entire bearing assembly. Further, the term “bearing,” as used herein, may refer to some or all of the assembly, as well as to various individual components that make up such assembly, and that a more particular or generalized description of the bearing 190 and its components will be apparent from the context.

During operation, as a limited-life and expendable powerplant, the gas turbine engine 100 can be configured in some examples as a “single-shaft” device, such that the compressor 120 and turbine 150 are both securely coupled to the common rotatable shaft 180 so that the three components rotate substantially as one. Within the present disclosure, the rotatable shaft 180 is considered to be common as long as it functions to have the compressor 120 and turbine 150 in the aforementioned cooperative, sympathetic rotatable arrangement; even if the rotatable shaft 180 is constructed into a singular whole from disparate, attachable components or means. Although shown as a multistage axial-based device, the compressor 120 may assume other configurations, including, for example, a centrifugal compressor or mixed-flow with one or multiple stages. Similarly, the combustor 140 may assume various configurations, including annular, cannular, reverse flow or the like, and in some examples it may include fuel injectors, nozzles or related atomizing or vaporizing means for introducing liquid fuel into a region where the compressed air from the compressor 120 and diffuser 130 becomes mixed with the fuel and is ignited. In addition, depending on how the gas turbine engine 100 is configured, the turbine 150 may be single-stage or multistage, while the exhaust 160 can assume various forms, such as fixed, axial or have other shapes (as well as convergent-divergent variants) as dictated by the mission of the airborne vehicle equipped with the gas turbine engine 100.

Regardless of whether the gas turbine engine 100 is configured as a turbojet or a turbofan, in an axial-based embodiment, the air undergoes compression and deceleration, followed by combustion of the air-fuel mixture and subsequent power generation as described below. First, the air is received into the inlet 110 and channeled to the compressor 120 where one or more rotor stages increase the kinetic energy of the air molecules (i.e., increase the air velocity) and one or more corresponding stator stages increase the air pressure. The diffuser 130 is configured to receive and slow down the high velocity air molecules exiting the final stage of the compressor 120. However, the air pressure does not substantially drop when the air passes through the diffuser 130. Instead, the air that leaves the diffuser 130 remains under substantially the same pressure but travels at a reduced speed by the time it arrives at the combustor 140. This condition helps avoid a high-speed air movement scenario that can result in flame blowout when the igniter-based burning of the fuel-air mixture occurs. Once the fuel and air mixture is ignited inside combustor 140, the amplifying effect of releasing the fuel's combustion energy in the presence of the compressed air releases large amounts of energy, which when passing through the one or more stages of turbine 150, cause the turbine 150 to spin. Because the turbine 150 and compressor 120 are in rigid rotational cooperation (i.e., they are mechanically linked) with each other through the rotatable shaft 180, the spinning movement of the turbine 150 causes the compressor 120 to rotate, thereby ensuring the continuous pressurization of the next portion of incoming air through inlet 110. Once the combusted gas stream has passed through the turbine 150, its velocity remains high enough as it passes through the exhaust 160.

In some implementations, the exhaust 160 is configured to have converging and diverging features so that when a fluid stream of high velocity combustion byproducts is being received from the turbine 150 (or optional from an afterburner, not shown in FIG. 1), it can be converted into forward thrust for the gas turbine engine 100 through the static structure 170. In some embodiments, the exhaust 160 may have a fixed or an adjustable tip diameter that would allow the performance of the gas turbine engine 100 to be tailored to particular missions or conditions, as well as to adjust its operation based on changes in in-flight conditions. Likewise, as previously discussed, the exhaust 160 may have various shapes in order to integrate into an airborne vehicle (not shown in FIG. 1). By way of example and not limitation, these shapes may include round, oblong, rectangular, angular shape or any suitable shape.

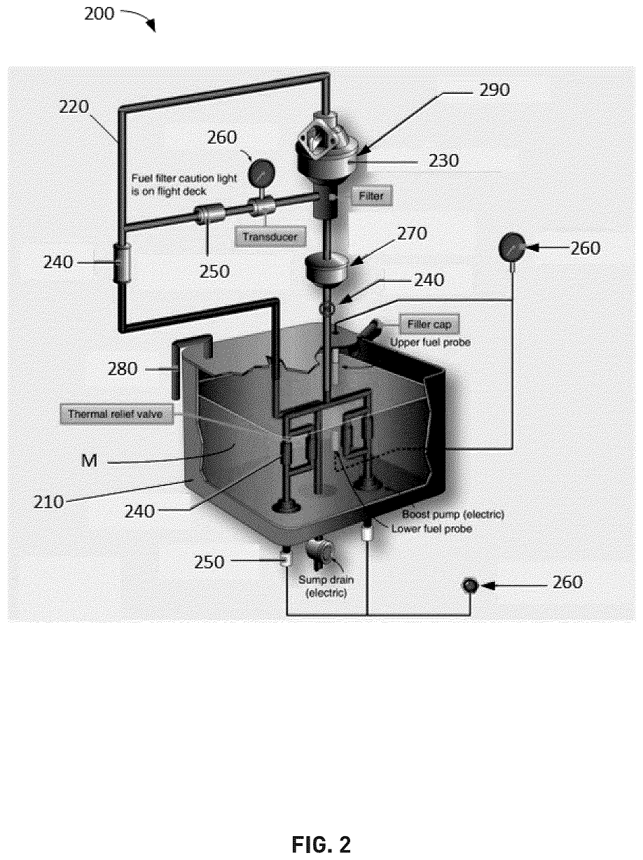

In addition to the various components and systems disclosed in conjunction with FIG. 1, a fuel delivery system 200 shown in FIG. 2 is also included, according to some embodiments. In some implementations, the type of fuel that may be stored within the fuel delivery system 200 and used by the combustor 140 may be determined by the type of the gas turbine engine 100, the engine's range of operation, mission or the like. All such fuels, regardless of the precise compositional breakdown of paraffins, naphthenes, olefins, aromatics and additives, are deemed to be compatible with the lubricant disclosed herein. Examples of such fuels—that typically include significant portions of one or both of kerosene and gasoline—may include, but are not limited to, J P10, J P-8, J P-7, J P-5, J et A, Jet A-1, Jet B or the like, including older variants such as J P-4. According to some embodiments, the lubricant may be included as one of the additives to the fuel. Other known additives, such as antioxidants, corrosion inhibitors, de-icing components, biocides, metal deactivators or the like may also be included, depending on the requirement and type of engine, its range of operation, mission, etc.

The fuel delivery system 200 includes a fuel tank 210, a conduit 220 and one or more fuel pumps 230. Numerous ancillary components, such as valves 240, switches 250, gauges 260, filters 270, vents 280 and control circuitry 290 may also be included. As previously discussed, the lubricant is part of a mixture M that may be stored in the fuel tank 210. In some embodiments, fuel tank 210 can be any suitable container or reservoir. The conduit 220 may form a “mixture flowpath” that delivers the mixture M (i.e., the mixture of fuel and lubricant) in liquid form to regions adjacent to the bearings 190 and the combustor 140. Although, conduit 220 is shown as having a rigid, structured configuration with clearly-defined tubular boundaries, this is not limiting. For example, conduit 220 when taken in conjunction with the overall flowpath enabled by the configuration of the gas turbine engine 100, the conduit 220 may have one or more portions with openings where mixture M can be released to preselected locations, according to some embodiments. In any event, conduit 220 is configured to deliver pre-defined portions of mixture M to one or more targeted areas (e.g., the bearings 190) requiring lubrication, as well to ensure the delivery of the mixture M to the combustor 140 of the gas turbine engine 100. In some implementations, conduit 220 may include a first portion that establishes fluid communication between the fuel tank 210 and the region adjacent to one or more of the bearings 190, as well as a second portion that establishes fluid communication between the fuel tank 210 and the combustor 140. In some embodiments, a single fuel pump 230 may be used to circulate a predetermined amount of mixture M to the bearings 190 and combustor 140. In other embodiments, multiple fuel pumps 230 may be employed.

In some embodiments, the lubricant within the mixture M delivered through conduit 220 is converted into a vapor only upon being introduced to a region within the gas turbine engine 100 that encompasses one or more of the plurality of bearings 190 disposed along an axial length of the rotatable shaft 180. M ore specifically, conversion of the lubricant from the liquid phase to the vapor phase is achieved when the lubricant in mixture M comes into physical contact with at least one of the bearings 190 that reside within a hot section of the gas turbine engine 100. In some implementations, the axial placement of one or more bearings 190 disposed in a hot section of the gas turbine engine 100 relative to the turbine 150 is such that the turbine 150 may be disposed radially outward from the one or more bearings 190 either directly or in a slightly overhung manner (i.e., axially downstream). Regardless of the precise placement of the one or more bearings 190 within a hot section, upon introduction of the fuel-lubricant mixture M to the region that surrounds or is otherwise adjacent the one or more bearings 190, causes the lubricant to transition from a liquid phase to a vapor phase and react with the hot surfaces of the one or more bearings 190.

In some embodiments, the mixture M is pre-heated (e.g., via exposure of the mixture M to the exhaust gases or related combustion byproducts) to induce vaporization of the lubricant within the bearing 190. In other words, pre-heating may be used as a means to facilitate or accelerate the phase change of the lubricant, according to some embodiments. For instance, a heat exchange mechanism may be used to facilitate such thermal interaction. According to some embodiments, such heat exchange mechanisms may include heat exchange between the mixture M and the combustion byproducts or between the mixture M and a suitable ignition source.

According to some embodiments, the conduit 220 of the fuel delivery system 200 may be bifurcated into a combustor inlet path for delivery of a first portion of the mixture M to the combustor 140, and into a bearing lubrication path for delivery of a second portion to one or more of the bearings 190. In some implementations, the first portion can be greater than the second portion, equal to the second portion, or less than the second portion. In further implementations, the control circuitry 290 can include a processor-based controller (not shown in FIG. 2) operable to receive and process inputs from the one or more gauges 260 or suitable sensors, and to control the operation of the valves 240, switches 250, filters 270, and vents 280 of the delivery system 200 based on the input provided, so that sufficient amount of the mixture M is directed to the combustor inlet path and/or the bearing lubrication path at all times. In some embodiments, the processed-based controller of the control circuitry 290 may be configured to execute pre-recorded instructions stored in memory modules within the control circuitry 290, or to receive instructions in real-time from a wireless source and to make adjustments to the flow and distribution of mixture M in real time. In some embodiments, the processor-based controller can be an integral part of the control circuitry 290 or external to the control circuitry 290—e.g., as part of another logic unit that is remote but communicatively coupled to the control circuitry 290.

When a bearing 190 is deprived of lubricants, it can experience a so-called “runaway” temperature rise, which can result in a catastrophic failure. This is because components of the bearing 190, which are packaged with tight clearances, begin to expand as the temperature of the bearing 190 rises. This situation caused additional friction between the components of bearing 190, further increase its temperature, and induces mechanical stress within the bearing assembly.

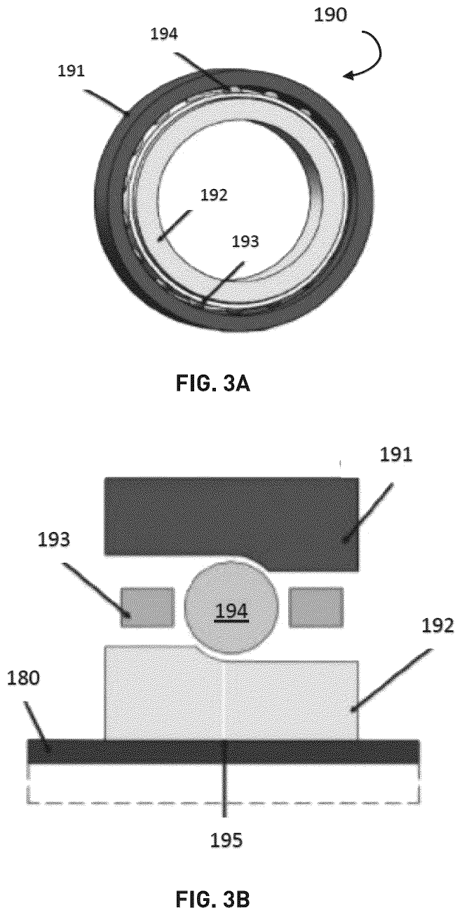

FIG. 3A is a plan-view of a roller bearing 190 shown as a representative example of a type of bearing 190 that may receive lubrication from a fuel-lubricant mixture M through the devices and methods disclosed herein. In FIG. 3A, the rotatable shaft 180 is not shown for simplicity. However, if the rotatable shaft 180 were shown, it would pass through the hollow middle portion of rolling element bearing 190, positioning rolling element bearing 190 around at least a portion of the rotatable shaft 180 in a mechanical coupling configuration. As shown in FIG. 3A, the rolling element bearing 190 is made up of various components including an outer ring 191, an inner ring 192, a cage 193, and a plurality of rolling elements, such as balls 194. In some embodiments, the rolling elements, represented herein as balls 194, may be linear or tapered rollers (neither of which are shown), among others. All such variants are within the spirit and the scope of the present disclosure.

FIG. 3B is a cross-sectional view of a top portion of the roller bearing 190 shown in FIG. 3A over a portion of rotatable shaft 180. Cross-sectional views of the ring 191, inner ring 192, cage 193, and of a single ball 194 are also shown. In some embodiments, an optional lubricant flowpath 195, which may be a part of or separate from the aforementioned mixture flowpath formed in part by conduit 220, may be formed through the inner ring 192. To the extent lubricant flowpath 195 is formed separate from the mixture flowpath of conduit 220, lubricant flowpath 195 is fluidically connected to conduit 220.

According to some embodiments, contact surfaces of roller bearing 190 are defined as those where relative movement (such as rotational movement) occurs to transfer the load between adjacent stationary and moving components. In some implementations, these contact surfaces are made from heat resistant materials that exhibit sufficient hardness, strength, and reactive properties in a manner consistent with the operation regime of the gas turbine engine 100. In some embodiments, contact surfaces are made from a suitable grade of steel in which the majority percentage of the alloying element is iron (Fe). Contact surfaces made from this type of steel, are not only capable of providing the necessary rotational support, but can advantageously react with the ATPE or other lubricant to facilitate the formation of a film coating thereon.

In some embodiments, the vapor phase lubrication from mixture M achieves a coefficient of friction in the range of 0.001-0.005 depending on the material used for the contact surfaces of bearing 190. At higher temperatures (e.g., between about 225° C. and about 550° C.), the reaction between the lubricant vapors and the material from which the contact surfaces are made forms a tribo-film containing iron (III) phosphate (FePO₄), iron (II) phosphide (Fe₂P), iron (I) phosphide (Fe₃P), or the like. According to some embodiments, phosphorus-rich tribo-films have been shown to reduce friction and wear. It is noted that components of bearing 190 not requiring lubrication may be made from steel-based alloys that may not react with the lubricant vapors.

According to some embodiments, bearings 190 may be lubricated with lubricant vapors in two general ways depending on the temperature of the contact surfaces to be lubricated. For instance, for bearings 190 disposed in hot sections of the gas turbine engine 100 which typically experience, under normal operating conditions, temperatures well above 200° C., lubrication occurs via a vapor phase deposition (V PD) mechanism. In V PD, the lubricant-containing vapor chemically reacts with the hot surface to form a lubricating film or coating. In this scenario, and because of the high temperatures present, the hot contact surfaces of the bearing 190, upon exposure to the lubricant vapors, react with the lubricant to form a low friction tribo-film that contains one or more of the aforementioned phosphorus-rich compounds. More specifically, at high temperatures (e.g., between about 225° C. and about 550° C.), high-iron containing bearing surfaces actively react with the lubricant vapors to form a tribo-film consisting of the compounds described above (e.g., FePO₄, Fe₂P, Fe₃P, or the like). Conversely, for bearings 190 disposed in cold sections of the gas turbine engine 100 that experience substantially lower temperatures, lubrication occurs via a vapor phase condensation (V PC) mechanism. In V PC, the lubricant-containing vapor is condensed on (as opposed to reacting with) the “cold” bearing surface to essentially maintain a form of liquid lubrication. In some embodiments, during the startup of the gas turbine engine 100—e.g., when all the bearing surfaces are at a lower temperature (i.e., below 200° C.)—VPC becomes the dominant lubrication mechanism. Once the contact surfaces of bearings 190 located in the hot sections of the gas turbine engine 100 are sufficiently heated, V PD becomes the main lubrication mechanism.

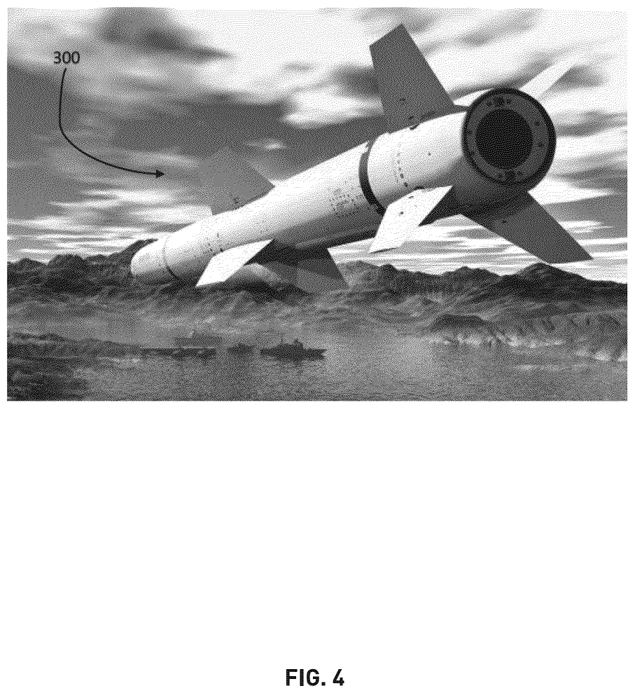

FIG. 4 shows an airborne vehicle in the form of a limited-life mission missile 300, according to some embodiments. As discussed above, the gas turbine engine 100 of FIG. 1 may power missile 300 (e.g., provide thrust to the missile) over its limited-life mission. According to some embodiments, a suitable lubricant, such as the aforementioned ATPE, is pre-mixed with the fuel of the gas turbine engine 100 to form a fuel-lubricant mixture M that can be stored in the fuel tank 210. During operation of the gas turbine engine 100 of missile 300, the mixture M is delivered via the delivery system 200 to the combustor 140 and to one or more bearings 190. In some embodiments, at least a portion of the lubricant in the mixture M evaporates when the mixture M is exposed to the hot contact surfaces of the bearing 190 and reacts with the hot contact surfaces to form a phosphorus-rich compound that sufficiently lubricates and protects the moving parts of the bearing. Advantageously, the bearings 190 in gas turbine engine 100 may be sufficiently lubricated during the entire mission of missile 300 without the need of a separate lubrication system, which reduces the design complexity, weight, and operational cost of the gas turbine engine 100.

According to some embodiments, it is established that very low lubricant concentrations within mixture M are sufficient to achieve desirable levels of lubrication for the bearings 190. M ore specifically, lubricant concentrations of equal to or less than about 5 percent by volume (% by vol.) may provide adequate lubrication to the moving parts of the bearings 190 (e.g., equal to about 4% by vol., equal to about 3% by vol., equal to about 2% by vol., equal to about 1% by vol., or equal to about 0.1% by vol.).

### Additional Considerations

Within the present disclosure, the terms “container”, “reservoir” and “fuel tank” (as well as their variants) are intended to include all such devices that may hold either the fuel alone, the lubricant alone or a combination of fuel and lubricant, and that the fluid contained therein will be apparent from the context.

Within the present disclosure, one or more of the following claims may utilize the term “wherein” as a transitional phrase. For the purposes of defining features discussed in the present disclosure, this term is introduced in the claims as an open-ended transitional phrase that is used to introduce a recitation of a series of characteristics of the structure and should be interpreted in like manner as the more commonly used open-ended preamble term “comprising” and its variants that do not preclude the possibility of additional acts or structures.

Within the present disclosure, terms such as “preferably”, “generally” and “typically” are not utilized to limit the scope of the claims or to imply that certain features are critical, essential, or even important to the disclosed structures or functions. Rather, these terms are merely intended to highlight alternative or additional features that may or may not be utilized in a particular embodiment of the disclosed subject matter. Likewise, it is noted that the terms “substantially” and “approximately” and their variants are utilized to represent the inherent degree of uncertainty that may be attributed to any quantitative comparison, value, measurement or other representation. As such, use of these terms represents the degree by which a quantitative representation may vary from a stated reference without resulting in a change in the basic function of the subject matter at issue.

Within the present disclosure, the use of the prepositional phrase “at least one of” is deemed to be an open-ended expression that has both conjunctive and disjunctive attributes. For example, a claim that states “at least one of A, B and C” (where A, B and C are definite or indefinite articles that are the referents of the prepositional phrase) means A alone, B alone, C alone, A and B together, A and C together, B and C together, or A, B and C together.

Within the present disclosure, the following claims are not intended to be interpreted based on 35 USC 112 (f) unless and until such claim limitations expressly use the phrase “means for” or “steps for” followed by a statement of function void of further structure. Moreover, the corresponding structures, materials, acts and equivalents of all means or step plus function elements in the claims below are intended to include any structure, material or act for performing the function in combination with other claimed elements as specifically claimed.

Within the present disclosure, the singular forms “a,” “an” and “the” include plural references unless the context clearly dictates otherwise. The modifier “about” used in connection with a quantity is inclusive of the stated value and has the meaning dictated by the context (for example, it includes at least the degree of error associated with the measurement of the particular quantity). The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9 to 1.1. Other meanings of “about” may be apparent from the context, such as rounding off, so, for example “about 1” may also mean from 0.5 to 1.4.

For the recitation of numeric ranges herein, each intervening number there between with the same degree of precision is explicitly contemplated. For example, for the range of 6 to 9, the numbers 7 and 8 are contemplated in addition to 6 and 9, and for the range 6.0 to 7.0, the number 6.0, 6.1, 6.2, 6.3, 6.4, 6.5, 6.6, 6.7, 6.8, 6.9 and 7.0 are explicitly contemplated.

The present description is for purposes of illustration and is not intended to be exhaustive or limited. M any modifications and variations will be apparent to those of ordinary skill in the art without departing from the scope and spirit of the present disclosure. Aspects of the present disclosure were chosen and described in order to best explain the principles and practical applications, and to enable others of ordinary skill in the art to understand the subject matter contained herein for various embodiments with various modifications as are suited to the particular use contemplated.

Unless otherwise defined, all technical and scientific terms used herein that relate to materials and their processing have the same meaning as commonly understood by one of ordinary skill in the art. In case of conflict, the present document, including definitions, will control.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A gas turbine engine comprising:
a static structure;
an inlet;
a compressor fluidly downstream of the inlet and secured to a rotatable shaft;
a combustor fluidly downstream of the compressor;
a turbine fluidly downstream of the combustor and secured to the rotatable shaft;
an exhaust fluidly downstream of the turbine;
a plurality of bearings disposed along an axial length of the rotatable shaft to provide rotational support between the static structure and at least one of the compressor and the turbine; and
a fuel system operable to deliver a mixture of fuel and lubricant sequentially to at least one of the plurality of bearings and the combustor so that during operation of the gas turbine engine, at least the lubricant within the mixture is in a liquid phase prior to being received by the at least one of the plurality of bearings, and in a vapor phase once the lubricant is delivered to the at least one of the plurality of bearings.

2. The gas turbine engine of claim 1, wherein the fuel system comprises:
a fuel tank configured to store the mixture;
a conduit fluidically connecting the fuel tank, the at least one of the plurality of bearings, and the combustor;
a fuel pump; and
a control circuitry operable to control delivery of the mixture from the fuel tank to the at least one of the plurality of bearings and the combustor via the conduit.

3. The gas turbine engine of claim 1, wherein the lubricant comprises an alkylated triphenyl phosphate ester.

4. The gas turbine engine of claim 3, wherein the mixture contains at least 5 percent by volume (% by vol.) alkylated triphenyl phosphate ester.

5. The gas turbine engine of claim 3, wherein the mixture contains at least 4% by vol. alkylated triphenyl phosphate ester.

6. The gas turbine engine of claim 3, wherein the mixture contains at least 3% by vol. alkylated triphenyl phosphate ester.

7. The gas turbine engine of claim 3, wherein the mixture contains at least 2% by vol. alkylated triphenyl phosphate ester.

8. The gas turbine engine of claim 3, wherein the mixture contains at least 1% by vol. alkylated triphenyl phosphate ester.

9. The gas turbine engine of claim 3, wherein the mixture contains at least 0.1% by vol. alkylated triphenyl phosphate ester.

10. The gas turbine engine of claim 1, wherein the mixture is delivered sequentially to the at least one of the plurality of bearings and the combustor through a conduit that defines at least a portion of a mixture flowpath within the fuel system.

11. The gas turbine engine of claim 10, wherein the conduit comprises a first portion that establishes fluid communication between the fuel tank and the at least one of the plurality of bearings and a second portion that establishes fluid communication between the fuel tank and the combustor.

12. The gas turbine engine of claim 1, wherein the at least one of the plurality of bearings is disposed within a hot section of the gas turbine engine.

13. The gas turbine engine of claim 12, wherein the at least one bearing disposed withing the hot section comprises a ball bearing.

14. The gas turbine engine of claim 13, wherein contact surfaces of the ball bearing are made of steel wherein a majority percentage of an alloying element is iron.

15. A method for providing lubrication to bearings of gas turbine engines, the method comprising:
providing fuel tank filled with a mixture of fuel and lubricant;
delivering at least a portion of the mixture to a bearing disposed along an axial dimension of a rotatable shaft of a gas turbine engine, wherein at least the lubricant within the mixture is a liquid form prior to being received by the bearing and in a vapor form once the mixture is introduced to at least one heated contact surface of the bearing;
reacting the at least one heated contact surface with at least a portion of the lubricant introduced thereto to form a lubricating layer on at the least one heated contact surface of the bearing;
delivering at least a remaining portion of the mixture from the bearing to a combustor of the gas turbine engine; and
igniting, within the combustor, at least the fuel that is contained within the remaining portion of the mixture.

16. The method of claim 15, wherein reacting comprises heating the at least one contact surface to a temperature sufficient to vaporize the lubricant in the mixture.

17. The method of claim 16, wherein the at least one contact surface is made from a steel-based material and the lubricant comprises an alkylated triphenyl phosphate ester.

18. The method of claim 15, wherein prior to delivering, preheating the mixture to facilitate vaporization of the lubricant once the mixture is delivered to the bearing.

19. The method of claim 18, wherein preheating comprises thermally exposing the mixture to exhaust gases from the gas turbine engine.

20. The method of claim 15, wherein delivering at least a portion of the mixture to the bearing comprises using a conduit fluidically connecting the fuel tank to the bearing and the combustor.
